(19) United States
(12) Patent Application Publication
(10) Pub. No.: US 2023/0337092 A1
(43) Pub. Date: Oct. 19, 2023

(54) Inter-System Handover

(71) Applicant: DISH Wireless L.L.C., Englewood, CO (US)

(72) Inventor: Xiaowen S. Robinson, Great Falls, VA (US)

(21) Appl. No.: 18/135,587

(22) Filed: Apr. 17, 2023

Related U.S. Application Data
(60) Provisional application No. 63/332,185, filed on Apr. 18, 2022.

(51) Int. Cl. H04W 36/14; H04W 36/30

(52) U.S. Cl. CPC H04W 36/142; H04W 36/304

(57) ABSTRACT

A method is described that includes determining that a user equipment (UE) device connected to a first cellular radio access network is in an area covered by both the first cellular radio access network and a second cellular radio access network. The first cellular radio access network is operated by a first service provider and the second cellular radio access network is operated by a second service provider. The method also includes identifying, at the UE device, that the second cellular radio access network is broadcasting an identifier associated with the first service provider. The method further includes handing over the UE device from the first cellular radio access network to the second cellular radio access network using the identifier associated with the first service provider.

### CROSS-REFERENCE TO RELATED APPLICATION

This application claims priority to U.S. Provisional Patent Application Ser. No. 63/332,185, filed on Apr. 18, 2022, the entirety of which is hereby incorporated by reference.

### TECHNICAL FIELD

This specification relates to handover of user equipment (UE) devices between cellular networks.

### BACKGROUND

Different cellular networks (e.g., cellular radio access networks, cellular core networks, etc.) can have varying levels of coverage in different locations. Thus, the ability to perform handovers of UE devices between cellular networks can enable better signal strength and continuous connection as the UE devices move between coverage areas. For example, Inter Radio Access Technology (Inter RAT) handover is a technology that enables UE devices to switch between different Radio Access Technologies (RATs) such as a 4G network and a 5G network operated by a single service provider.

### SUMMARY

The technology described herein relates to handovers between cellular networks (e.g., cellular radio access networks, cellular core networks, etc.) operated by different service providers. These handovers can be referred to as “inter-system handovers,” “inter-operator handovers,” or “inter-carrier handovers.” For example, an inter-system handover can switch a connection of a UE device from a home carrier's 5G cellular network to a roaming partner's 5G cellular network, or from a home carrier's 5G cellular network to a roaming partner's 4G cellular network. In some implementations, handovers can be performed in the opposite direction (sometimes referred to herein as “reverse handovers”), from a roaming partner's 5G cellular network to a home carrier's 5G cellular network, or from a roaming partner's 4G cellular network to a home carrier's 5G cellular network. In general, a handover is a procedure that transfers one or more sessions of a UE device from a current serving cell to another serving cell. Inter-system handovers differ from traditional roaming in that a UE device can transition from one carrier network to another without experiencing disconnection while transferring data or conducting voice calls. The ability to perform an inter-system handover is sometimes referred to as “mobility.”

Various implementations of the technology described herein may provide one or more of the following advantages.

In some cases, the technology described herein can enable the smooth transitioning of a UE device from a first cellular network operated by a first service provider to a second cellular network operated by a second service provider, for example, when the first cellular network has limited coverage. This can improve the quality of voice calls and data downloads and extend the range of areas where the UE device is able to receive cellular coverage. For example, in some implementations, the UE device is able to connect to one of multiple roaming partner networks from a home carrier network (i.e., a cellular network operated by a service provider that the UE device is subscribed to; sometimes referred to herein as a “home network”). This can enable the UE device to receive cellular coverage in areas covered by various roaming partner networks, but not covered by the UE device's home carrier network. In some cases, the inter-system handovers can be performed such that phone calls are not dropped or data transfers interrupted when switching between cellular networks.

In some cases, the UE device can connect to a second cellular network that broadcasts a network identifier such as a multi-operator core networks (MOCN) public land mobile network (PLMN) that is associated with the UE device's home carrier network. The MOCN PLMN can be distinct from a PLMN broadcasted by the home carrier network and from a primary PLMN broadcasted by the second cellular network. This can have the advantage of distinguishing UE devices that are subscribed to a service provider of the second cellular network from UE devices that roam onto the second cellular network but are subscribed to a different service provider's cellular network. Distinguishing between these UE devices can in turn enable treating call processing differently for subscribed “home” UE devices and roaming UE devices. For example, the provider of the second cellular network can handover a roaming UE device back to its home carrier network from the second cellular network when possible, while keeping a UE device that is subscribed to provider of the second cellular network on the second cellular network. Using the MOCN PLMN, which is associated with the UE device's home carrier network and broadcasted at border areas by the second cellular network, can also have the advantage of effectively preventing the UE device from being handed over to the second cellular radio access network while the UE device is still within the coverage area of its home carrier network.

In some cases, the technology described herein can have the advantage of avoiding performing inter-system handovers when such handovers would be inappropriate or not allowed, for example, for regulatory reasons. For example, during active emergency calls, performing an inter-system handover can be inappropriate. In North America, if a UE device makes an emergency call using a roaming partner network, local breakout standards state that the roaming partner network should not route the call back to the UE device's home network. The roaming partner network must carry the call whether or not the UE is subscribed to that network. Accordingly, in some implementations, the technology described herein can include checking that the UE device is not participating in an active emergency call prior to performing an inter-system handover. Inter-system handovers can therefore be avoided during active emergency calls, and the UE device's home network can inform the roaming partner network about the active emergency call so that that roaming partner network does not drop the call.

In a general aspect, a method performed by a network environment and a UE device is provided. The method includes determining that a user equipment (UE) device connected to a first cellular radio access network is in an area covered by both the first cellular radio access network and a second cellular radio access network. The first cellular radio access network is operated by a first service provider and the second cellular radio access network is operated by a second service provider. The method further includes identifying, at the UE device, that the second cellular radio access network is broadcasting an identifier associated with the first service provider. The method further includes performing a handover of the UE device from the first cellular radio access network to the second cellular radio access network using the identifier associated with the first service provider.

Implementations of the method can include one or more of the following features. The UE device can be subscribed to the first service provider. The identifier can be a multi-operator core networks (MOCN) PLMN. The method can include identifying, at the second cellular network, that the UE device is subscribed to the first service provider rather than the second service provider based on the identifier. The method can include determining, prior to performing the handover of the UE device, that the identifier is included in a list of candidate identifiers stored at the UE device. Other identifiers included in the list of candidate identifiers can be associated with the first service provider and can be broadcasted by other service providers that operate other cellular radio access networks. The method can include comparing, prior to performing the handover of the UE device, a signal strength of the first cellular radio access network with a first threshold value and comparing, prior to performing the handover of the UE device, a signal strength of the second cellular radio access network with a second threshold value. The method can further include determining that the signal strength of the first cellular radio access network satisfies a first threshold condition for initiating the handover of the UE device and determining that the signal strength of the second cellular radio access network satisfies a second threshold condition for initiating the handover of the UE device. Determining that the signal strength of the first cellular radio access network satisfies the first threshold condition can include determining, at the UE device and/or at the first cellular radio access network, that the signal strength of the first cellular radio access network satisfies the first threshold condition. Determining that the signal strength of the second cellular radio access network satisfies the second threshold condition can include determining, at the UE device and/or at the first cellular radio access network, that the signal strength of the second cellular radio access network satisfies the second threshold condition. The method can include configuring, at the UE device, a different identifier that is broadcast by the second cellular radio access network, wherein the different identifier enables the UE device to perform handover or cell reselection to the second cellular radio access network when the UE device enters an area that is not covered by the first cellular radio access network. The method can include reestablishing a voice and/or data connection of the UE device with the first cellular core network subsequent to performing the handover of the UE device from the first cellular radio access network to the second cellular radio access network. The method can further include waiting for an active call or a data session to terminate at the UE device (e.g., while connecting to the second cellular radio access network and entering the first cellular radio access network coverage area), and waiting for the UE device to enter an idle mode prior to reestablishing the connection of the UE device with the first cellular radio access network.

In another general aspect, a system is provided. The system includes a first cellular radio access network operated by a first service provider, a second cellular radio access network operated by a second service provider, and a UE device connected to the first cellular radio access network. When the UE device is located in an area covered by both the first cellular radio access network and the second cellular radio access network, the UE device is configured to identify that the second cellular radio access network is broadcasting an identifier associated with the first service provider. The first cellular radio access network is configured to perform a handover of the UE device from the first cellular radio access network to the second cellular radio access network using the identifier associated with the first service provider.

Implementations of the system can include one or more of the following features. The identifier associated with the first service provider can distinguish subscribers to the first service provider that are connected to the second cellular radio access network from subscribers to the second service provider that are connected to the second cellular radio access network. The identifier can be a multi-operator core networks (MOCN) PLMN. The identifier can be included in a list of candidate identifiers stored at the UE device. The first cellular radio access network can be configured to perform the handover of the UE device upon (i) comparing a signal strength of the first cellular radio access network with a first threshold value, (ii) comparing a signal strength of the second cellular radio access network with a second threshold value (iii) determining that the signal strength of the first cellular radio access network satisfies a first threshold condition for initiating the handover of the UE device, and (iv) determining that the signal strength of the second cellular radio access network satisfies a second threshold condition for initiating the handover the UE device. The UE device can be configured to reestablish a connection with the first cellular radio access network subsequent to the first cellular radio access network performing the handover of the UE device from the first cellular radio access network to the second cellular radio access network. In some implementations, the UE device does not reestablish the connection with the first cellular radio access network during an active call or a data session at the UE device.

In another general aspect, a non-transitory computer readable medium is provided. The non-transitory computer readable medium stores instructions that are executable by a processing device, and upon such execution cause the processing device to perform operations. The operations include determining that a user equipment (UE) device connected to a first cellular radio access network is in an area covered by both the first cellular radio access network and a second cellular radio access network. The first cellular radio access network is operated by a first service provider and the second cellular radio access network is operated by a second service provider. The operations also include identifying, at the UE device, that the second cellular radio access network is broadcasting an identifier associated with the first service provider. The operations further include performing a handover of the UE device from the first cellular radio access network to the second cellular radio access network using the identifier associated with the first service provider.

Implementations of the non-transitory computer readable medium can include one or more of the following features. The UE device can be subscribed to the first service provider. The identifier can be a multi-operator core networks (MOCN) PLMN. The operations can include identifying, at the second cellular radio access network, that the UE device is subscribed to the first service provider rather than the second service provider based on the identifier. The operations can include determining, prior to performing the handover of the UE device, that the identifier is included in a list of candidate identifiers stored at the UE device. Other identifiers included in the list of candidate identifiers can be associated with the first service provider and can be broadcasted by other service providers that operate other cellular radio access networks. The operations can include comparing, prior to performing the handover of the UE device, a signal strength of the first cellular radio access network with a first threshold value and comparing, prior to performing the handover of the UE device, a signal strength of the second cellular radio access network with a second threshold value. The operations can further include determining that the signal strength of the first cellular radio access network satisfies a first threshold condition for initiating the handover of the UE device and determining that the signal strength of the second cellular radio access network satisfies a second threshold condition for initiating the handover of the UE device. Determining that the signal strength of the first cellular radio access network satisfies the first threshold condition can include determining, at the UE device and/or at the first cellular radio access network, that the signal strength of the first cellular radio access network satisfies the first threshold condition. Determining that the signal strength of the second cellular radio access network satisfies the second threshold condition can include determining, at the UE device and/or at the first cellular radio access network (e.g., based on UE measurement reports) that the signal strength of the second cellular radio access network satisfies the second threshold condition. The operations can include reestablishing a connection of the UE device with the first cellular radio access network subsequent to performing the handover of the UE device from the first cellular radio access network to the second cellular radio access network. The operations can further include waiting for an active call or a data session to terminate at the UE device (e.g., while connecting to the second cellular radio access network and entering the first cellular radio access network coverage area), and waiting for the UE device to enter an idle mode prior to reestablishing the connection of the UE device with the first cellular radio access network.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1 is a diagram of an exemplary network environment and a user equipment (UE) device connected to the exemplary network environment.

FIG. 2 is a diagram of coverage scenarios involving two cellular networks.

FIG. 3 is a flowchart of a process for handing over a UE device from a first cellular network to a second cellular network.

FIG. 4 is a flowchart of a process for rejecting a request to accept a handover of a UE device participating in an emergency call.

FIG. 5 is a flowchart of a process for receiving a rejection to perform a handover of a UE device participating in an emergency call.

FIG. 6 is a diagram illustrating an example of a computing environment.

### DETAILED DESCRIPTION

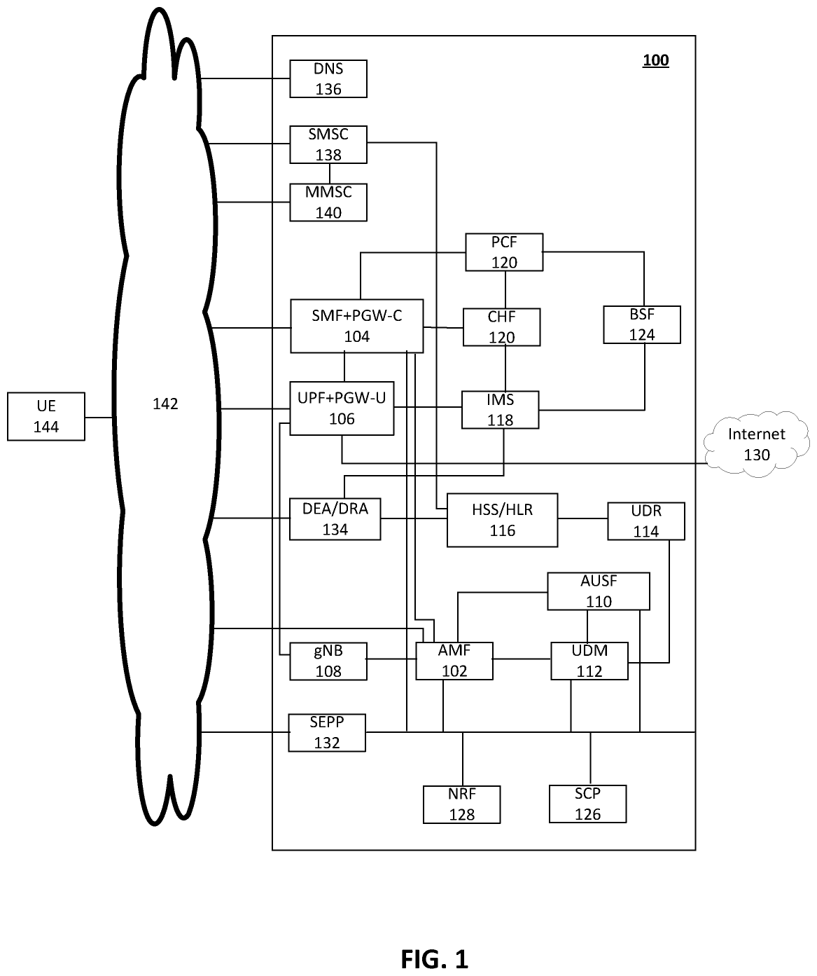

FIG. 1 depicts a diagram of an exemplary network environment 100 and a user equipment (UE) device 144 connected to the exemplary network environment. As used herein, a network environment (sometimes referred to herein simply as an environment) refers to a set of multiple devices, modules, and functions that are configured to jointly enable wireless communication. For example, a network environment can include a 5G network that includes a set of multiple devices, radio access network (RAN)/core network functions, and application functions that are configured and integrated to jointly enable wireless communication. An environment, such as the environment 100, can be a portion of a 5G New Radio (“5G-NR” or simply “5G”) cellular network environment. Standards for cellular network architectures have previously been described, for example, in 3GPP TS 23.501 (for 5G networks) and 3GPP TS 23.401 (for 4G long-term evolution “LTE” networks) (the entireties of which are hereby incorporated by reference). While FIG. 1 shows an exemplary architecture for a network environment (i.e., environment 100), it is not intended to be limiting. The lines depicted in FIG. 1 that connect network elements are indicative of the possibility of direct communication between those network elements.

Network environment 100 includes a packet core network, which includes an access management function (AMF) 102, a session management function and packet data network gateway-control module (SMF+PGW-C) 104, a user plane function and packet data network gateway-user plane module (UPF+PGW-U) 106, and a policy control function (PCF) 120. The AMF 102 receives all connection and session related information from one or more user equipment (UE) devices 144, and handles connection and mobility management tasks. The AMF 102 forwards all messages related to session management to the SMF+PGW-C module 104. The SMF+PGW-C module 104 and UPF+PGW-U module 106 jointly manage sessions and are configured using Control and User Plane Separation (CUPS). The PCF 120 communicates with the SMF+PGW-C module 104, governing control plane functions via defined policy rules. The UPF+PGW-U module 106 can provide access to the Internet 130 for data applications and the IP Multimedia Subsystem (IMS) core module 118 for voice applications. The IMS core module 118 is a separate application core network from the packet core network and supports voice services, messaging, voice calls, etc.

The environment 100 can further include a charging function (CHF) 122 and a binding support function (BSF) 124. The CHF 122 supports online and offline charging features and completes billing functions. The BSF 124 tracks sessions that are located anywhere in the environment 100, but share common criteria, such as subscriber identifiers. The BSF 124 communicates with the PCF 120 and binds application-function requests to specific PCF instances, enabling policy scaling of the environment 100.

The environment 100 also includes a gNB 108 (i.e., a 5G base station), which handles run-side aspects of the network environment 100 and communicates, either directly or indirectly, with the packet core network elements such as AMF 102, SMF+PGW-C module 104, and UPF+PGW-U module 106.

The environment 100 further includes network elements to manage user or subscriber information. For example, the environment 100 includes an authentication service function (AUSF) 110 for user authentication and a unified data management (UDM) module 112. The user database is stored in a unified data repository (UDR) 114. The UDM 112 communicates with the AMF 102, AUSF 110, and the UDR 114 to provide centralized control of network user data. For interworking with 2G, 3G, and 4G network elements, the environment 100 also includes a Home Subscriber System and Home Location Register (HSS/HLR) module 116, which stores subscriber information, location and SIM details, and authentication keys.

The environment 100 further includes a service communication proxy (SCP) 126 and a network repository function (NRF) 128. In accordance with current 5G standards, network functions are based on HTTP version 2, and use the SCP 126 and NRF 128 to communicate. The NRF 128 is used to discover network functions in the environment 100, and the SCP 126 is used to provide a single point of entry for a cluster of discovered network functions, serving as a central control point in the signaling network core.

The environment 100 further includes a security edge protection proxy (SEPP) 132, a diameter edge agent and diameter routing agent (DEA/DRA) module 134, and a domain name system (DNS) 136. The SEPP 132 is a security proxy through which all signaling traffic across operator networks is expected to transit. The DEA/DRA module 134 manages traffic and congestion of messages routed across the environment 100, routing signaling traffic and performing load balancing, relay, proxy and redirect functions within a carrier or interworking with other carriers. The DNS 136 is a naming database in which internet domain names are located and translated into internet protocol (IP) addresses.

The environment 100 further includes a short message service center (SMSC) 138 and a multimedia message service center (MMSC) 140 configured to receive, store, route, and forward SMS messages and MMS messages, respectively.

The network environment 100 is configured to interact with external systems 142. In some implementations, the external systems 142 can include another network such as a 4G or 5G roaming partner network. For example, the environment 100 can interact with a roaming partner network using an IP Packet eXchange (IPX) telecommunications interconnection model provided between the two network environments. In other examples, the environment 100 can interact directly with the roaming partner network environment without an IPX provider in between the two networks.

In some implementations, the external systems 142 can include a message aggregator configured to aggregate messages and route a portion of the aggregated messages to the environment 100. For example, the aggregated messages can be SMS or MMS messages.

The UE 144 can interact with the network environment 100 indirectly through the external systems 142 or directly with the network environment 100 (e.g., via the gNB 108). In some cases, the UE 144 can be a subscriber to the network environment 100 (e.g., a subscriber to a service provider of the cellular network). In other cases, the UE 144 can be a non-subscriber roaming on the network environment 100.

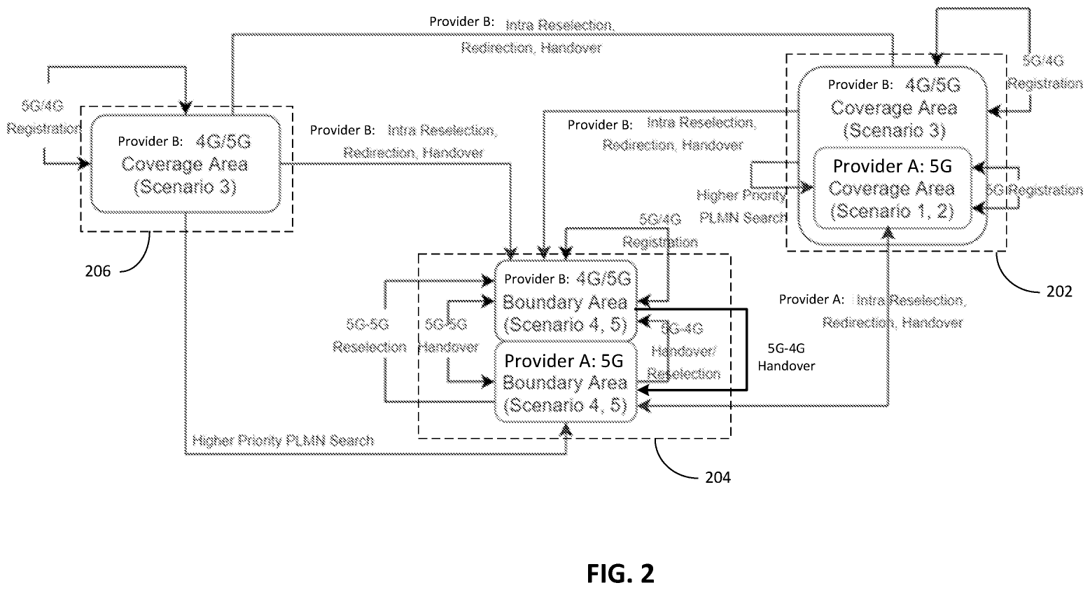

Referring now to FIG. 2, the existence of multiple cellular networks can create various coverage scenarios. Each of the multiple cellular networks can include substantially similar network elements to the exemplary environment 100 described in relation to FIG. 1. In FIG. 2, two cellular networks corresponding to two different service providers (i.e., “Provider A” and “Provider B”) are shown. Areas where Provider A's cellular network provides signal are depicted in red. Areas where Provider B's cellular network provides signal are depicted in purple. In some implementations, the cellular network operated by Provider A can be a home network for a UE device (e.g., UE device 144) and the cellular network operated by Provider B can be a roaming partner network that the UE device is configured to connect to.

Referring to box 202, in some areas both Provider A's cellular network and Provider B's cellular network can provide strong coverage. In these areas, a UE device (e.g., UE device 144) may prioritize a network identifier (e.g., a PLMN) associated with Provider A's network if the UE device 144 is subscribed to Provider A's cellular network as its home network. In general PLMNs can be thought of as codes representing a particular service provider or network. While the technology described herein is described as broadcasting PLMNs, other network identifiers or service provider identifiers can be used. In this case, PLMN prioritization can cause the UE device to prioritize connection to Provider A's cellular network and can prevent the UE device from incurring costs from roaming on Provider B's network.

Referring now to box 204, some areas can be designated as boundary areas (sometimes referred to as border cells), within which inter-system handovers can be performed. Boundary areas can be designated based on the sites of cell towers and base stations associated with Provider A's cellular network and Provider B's cellular network. For example, a boundary area may be designated near the outer edge of Provider A's cellular network or near the outer edge of Provider B's cellular network.

Inter-system handovers can include handovers from a 5G network operated by Provider A to a 5G network operated by Provider B, or from a 5G network operated by Provider A to a 4G network operated by Provider B. Inter-system handovers can also include handovers in the reverse direction, handing over the UE device from a cellular network operated by Provider B to a cellular network operated by Provider A (sometimes referred to as “reverse handovers”).

To enable inter-system handovers from Provider A's network to Provider B's network, service providers such as Provider A and Provider B may identify boundary areas between the two networks and exchange border area information (e.g., frequencies). Provider A can then configure its own PLMNs and frequencies and/or Provider B's broadcasted PLMNs and frequencies in Provider A's Core and Radio Access Networks. For example, boundary cells in Provider's A network can be configured either manually or via Automatic Neighbor Relation (ANR) with Provider B's neighbor cell frequencies, identifiers, and other parameters, as well as handover criteria and measurement objects. This configuration can be communicated to the UE devices subscribed to Provider A's cellular network so that the UE devices can recognize when they are located at a boundary area and identify candidate PLMNs to which they can connect (e.g., in a “neighbor list”). In some implementations, the neighbor list can include multiple identifiers (e.g., PLMNs) corresponding to additional cellular networks that the UE device can connect to. These additional cellular networks can be operated by a number of other service providers, each of them broadcasting an identifier associated with Provider A.

To enable inter-system handovers from Provider B's network to Provider A's network, Provider B can configure its own Core and Radio Access Networks in an analogous manner and similarly communicate configuration information to the UE devices subscribed to Provider A's cellular network.

Various thresholds can be established for controlling when an inter-system handover can occur. A first threshold can correspond to a signal strength threshold for a serving cell of a first cellular network (e.g., the UE device's home carrier network) and the second threshold can correspond to a signal strength threshold for a neighbor cell of a second cellular network. In some implementations, prior to initiating an inter-system handover, a determination can be made that two threshold conditions are satisfied and handover criteria is met. In some implementations, satisfaction of the threshold conditions can be considered part of the handover criteria. In an example, the inter-system handover can be initiated in response to determining that the signal strength of the serving cell is below the first threshold and that the signal strength of an inter-RAT (inter-radio access technology) neighbor cell is greater than the second threshold at the same time. In some implementations, hysteresis methods can be used to prevent undesirably high frequencies of handovers back and forth between the first cellular network and the second cellular network. The first threshold and the second threshold can each be based on signal measurements such as Reference Signals Received Power (RSRP) and/or Reference Signals Received Quality (RSRQ). In some implementations, the signal measurements can be obtained from measurement reports received from the UE.

In some implementations, there can be multiple configurations with multiple thresholds, of which some are used for managing idle mode mobility and others are used for controlling connected mode handover. In addition, for better performance, the parameters can be configured in a way that makes connected mode mobility more aggressive than idle mode mobility. For example, the parameters (e.g., the threshold values of the first threshold and the second threshold described above) can be established so as to make the threshold conditions for initiating an inter-system handover more easily satisfied when the UE device is in a connected mode (e.g., with live traffic going to and/or from the UE device such as voice call or data download/session) compared to an idle mode. This can have the effect of causing the UE device to switch to a second cellular network (e.g., Provider B's network) sooner when the UE device is in a connected mode. This can prevent calls from being dropped prior to the successful handover of the UE device from one network to another.

When the UE device is in an idle mode (e.g., a mode in which no NAS (Non Access Stratum) signaling connection exists between the UE device and the network), mobility between cellular networks can include a cell reselection procedure, which is a mechanism to change a cell that the UE device is camped on while staying in an idle mode. When camped on a cell, the UE device can regularly search for others cells to connect to according to certain cell reselection criteria. If a better cell is found, and the UE is allowed to connect to the better cell, then that cell is selected for the UE to connect to. Cell reselection criteria can include a signal strength, a PLMN priority, and/or stored information on the UE device. While the term “cell reselection” is sometimes used separately from the term “handover” to distinguish between idle mode mobility and connected mode mobility, this document uses the term “handover” broadly to refer to both idle mode mobility and connected mode mobility. Thus, handover processes can be understood to control both the mobility of UE devices in connected states (e.g., EMM-Registered, ECM-Connected and RRC-Connected states) and idle states (e.g., EMM-Registered, ECM-Idle and RRC-Idle states).

Provider A's cellular network can be associated with a first PLMN and Provider B's network can be associated with a second PLMN, each used by a UE device to switch between the networks. However, in a boundary area, additional PLMNs may be broadcast by network elements (e.g., gNBs, eNBs) of Provider A's cellular network and/or Provider B's cellular network.

As an example, if an inter-system handover is being performed from Provider A's cellular network to Provider B's cellular network at a boundary area, Provider B's cellular network can be configured to broadcast an additional PLMN that can be latched onto by the UE device in order to complete the handover. In some cases, the additional PLMN can be a MOCN PLMN and can be associated with Provider A. The MOCN PLMN can be distinct from one or more other PLMNs broadcast by Provider B's cellular network. This enables the MOCN PLMN to help Provider B distinguish between (i) UEs connected to Provider B's cellular network that are subscribed to Provider A's network versus (ii) UEs connected to Provider B's cellular network that are subscribed to Provider B's network.

At the boundary area, a UE device that is subscribed to and connected to Provider A's cellular network can be configured to identify that the signal strength of a serving cell of Provider A's network has fallen below a first threshold and that the signal strength of a neighbor cell of Provider B's network is above a second threshold to initiate a handover process. The UE device can also be configured to detect the PLMNs being broadcasted by Provider B's cellular network, and recognize that a MOCN PLMN being broadcasted by Provider B's cellular network is on the UE's neighbor list (e.g., a stored list of equivalent PLMNs) as a candidate PLMN to connect to. In some implementations, Provider A's cellular network communicates with the UE device to provide the UE device with the list of equivalent PLMNs with which the UE device can utilize for performing handover and cell reselection when certain conditions are met.

Once the inter-system handover from Provider A's cellular network to Provider B's cellular network is completed, Provider B's cellular network can dynamically update the UE device with equivalent PLMNs that the UE device can connect to via handover or cell reselection procedures in order to enable the UE device to continue using Provider B's cellular network beyond the boundary area. For example, referring to box 206 (shown in FIG. 2), this can include areas where Provider B's cellular network has coverage, but where Provider A's cellular network does not. In such areas, Provider B's cellular network may not broadcast a MOCN PLMN associated with Provider A. Instead, Provider B's cellular network can configure a distinct PLMN (sometimes referred to as an “equivalent PLMN”) based on the serving PLMN for the UE device to connect to. By connecting to this equivalent PLMN, the UE device can use Provider B's network in areas where Provider A's network does not provide coverage.

In some implementations, inter-system handovers between Provider A's network and Provider B's network can be supported only in one direction (e.g., from Provider A to Provider B). This may reduce the amount of modifications that must be made to the cellular network of Provider B to support handover applications (relative to implementations that support reverse handovers). Such one-directional inter-system handovers can also be desirable in settings where Provider B's network has substantially broader coverage than Provider A's network and is unlikely to need to perform a reverse handover to Provider A's network to take advantage of Provider A's coverage in areas not covered by Provider B.

In implementations where reverse handovers are not supported, a UE device may still need to be able to come back to Provider A's network (e.g., for economic purposes) if the UE device is subscribed to that network (e.g., if the network is the UE's home network). In some implementations, when the UE device is in an idle mode and roaming on Provider B's network, the UE device can be configured to search for a PLMN associated with Provider A's network and switch back to Provider A's network when the UE device detects the PLMN from Provider A's network. Alternatively, when the UE device is in a connected mode and roaming on Provider B's network, Provider B can choose not to perform a handover, allowing the UE device to stay connected to Provider B's network and to later switch to Provider A's network upon entering an idle mode.

In some implementations, reverse handovers from Provider B to Provider A can be supported, and for most applications, reverse handovers may be implemented in a substantially similar manner to the inter-system handovers described from Provider A to Provider B. However, with respect to some applications, such as emergency calls, the implementation of reverse handovers may be different.

In North America, standards require local breakout capability for emergency calls, meaning that emergency calls cannot be routed back to a home network that the UE device belongs to. One reason for this requirement is to enable emergency response personnel to receive precise location information about the UE device that is known by the cellular network on which the emergency call is originated using the UE device. Thus, if a UE device is subscribed to Provider A's cellular network (i.e., Provider A's cellular network is the “home network” of the UE device), but is roaming on Provider B's network while making an emergency call, a reverse handover from Provider B to Provider A may not be desirable, supported, or even legally permitted. Maintaining the call on Provider B's network regardless of whether or not the UE device is a subscriber to Provider B's cellular network obviates the possibility of an emergency call being dropped during a transfer process and allows for location updates to be provided to a public-safety answering point (PSAP).

When the UE device is participating in an active emergency call on Provider B's network and enters a boundary area, the UE device, in a connected mode, can attempt to initiate a handover from Provider B's network to Provider A's network, as described above. For example, the UE device can be configured to perform or obtain signal measurements of Provider B's network as well as signal measurements from other networks (such as Provider A's network). Based on the UE device's measurements, Provider B's cellular network (e.g., a gNB/eNB and packet core of the network) can communicate with Provider A's network to request a handover without the information that the UE device is participating in an active emergency call. In response to receiving the handover request, Provider A's network can be configured to identify the UE device's ongoing call as an emergency call. For example, Provider A's cellular network can identify the call as an emergency call by checking an Access Point Name (APN) or Data Network Name (DNN) associated with the PDU session. During an emergency call, the APN or DNN may include a particular identifier (e.g., “SOS”) that identifies the call as an emergency call. Upon identifying that the UE device is participating in an active emergency call, Provider A can be configured to reject the request to perform a handover of the call. In some implementations, this can be done by Provider A transmitting to Provider B a special identifier or code (e.g., a specific cause code). The special cause code can indicate to Provider B that the UE device is participating in an active emergency call and that Provider B should continue to carry the call. In some implementations, the handover from Provider B to Provider A can be postponed until termination of the emergency call. For PDU sessions that are not for emergency services, the handover from Provider B to Provider A can be initiated immediately.

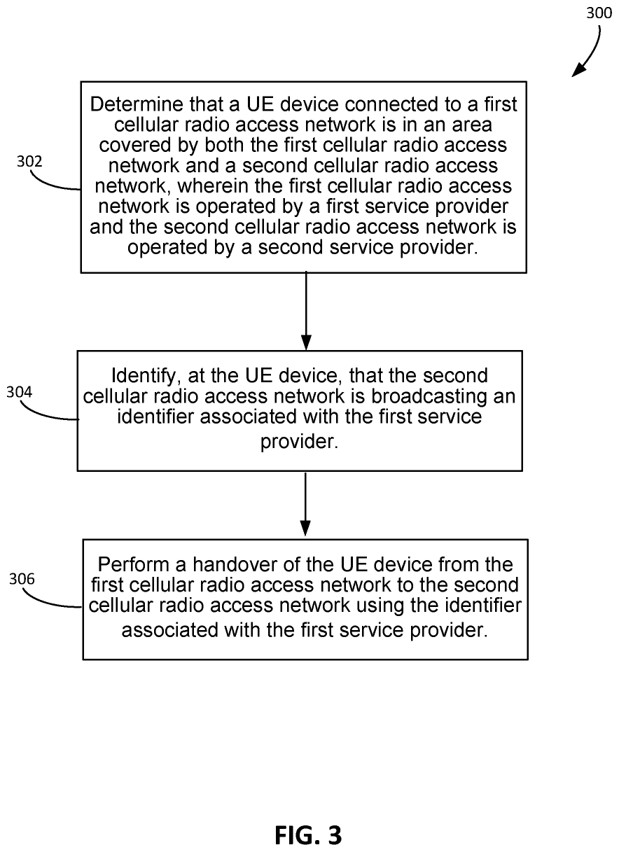

FIG. 3 illustrates an example process 300 for handing over a UE device from a first cellular radio access network to a second cellular radio access network. Operation of the process 300 can be executed by the UE device or by the first cellular radio access network.

Operations of the process 300 include determining that a UE device connected to a first cellular radio access network is in an area covered by both the first cellular radio access network and a second cellular radio access network, wherein the first cellular radio access network is operated by a first service provider and the second cellular radio access network is operated by a second service provider (302). For example, the first cellular provider can correspond to Provider A and the second cellular provider can correspond to Provider B, as described above in relation to FIG. 2. The UE device can be subscribed to the first service provider.

Operations of the process 300 also include identifying, at the UE device, that the second cellular radio access network is broadcasting an identifier associated with the first service provider (304). For example, the identifier can be a PLMN or a MOCN PLMN and can be used to identify whether the UE device is a “home” UE device or a roaming UE device

Operations of the process 300 further include performing a handover of the UE device from the first cellular radio access network to the second cellular radio access network using the identifier associated with the first service provider (306).

Optionally, operations of the process 300 can include comparing and analyzing, prior to performing the handover of the UE device, the signal strength measurement reports, of the first and the second cellular radio access networks, performed and sent by the UE device, with the configured handover criteria. For example, the operations can include comparing, prior to performing the handover of the UE device, a signal strength of the first cellular radio access network with a first threshold value, and comparing, prior to performing the handover of the UE device, a signal strength of the second cellular radio access network with a second threshold value. The operations can further include determining that the signal strength of the first cellular radio access network satisfies a first threshold condition for initiating the handover of the UE device and determining that the signal strength of the second cellular radio access network satisfies a second threshold condition for initiating the handover of the UE device. Determining that the signal strength of the first cellular radio access network satisfies the first threshold condition can be done at the UE device and/or at the first cellular radio access network. Determining that the signal strength of the second cellular radio access network satisfies the second threshold condition can be done at the UE device and/or at the first cellular radio access network (e.g., based on UE measurement reports).

Optionally, operations of the process 300 can include configuring, at the UE device, a different PLMN that is broadcast by the second cellular radio access network. The different PLMN enables the UE device to perform handover or cell reselection to the second cellular radio access network when the UE device enters an area that is not covered by the first cellular radio access network. For example, the different PLMN can correspond to the “equivalent PLMN” described above in relation to FIG. 2.

Optionally, operations of the process 300 can include reestablishing a connection of the UE device with the first cellular radio access network subsequent to performing the handover of the UE device from the first cellular radio access network to the second cellular radio access network (e.g., while the UE device is in an idle mode). The operations can further include waiting for an active call or a data download/session to terminate at the UE device and waiting for the UE device to enter an idle mode prior to reestablishing the connection of the UE device with the first cellular radio access network.

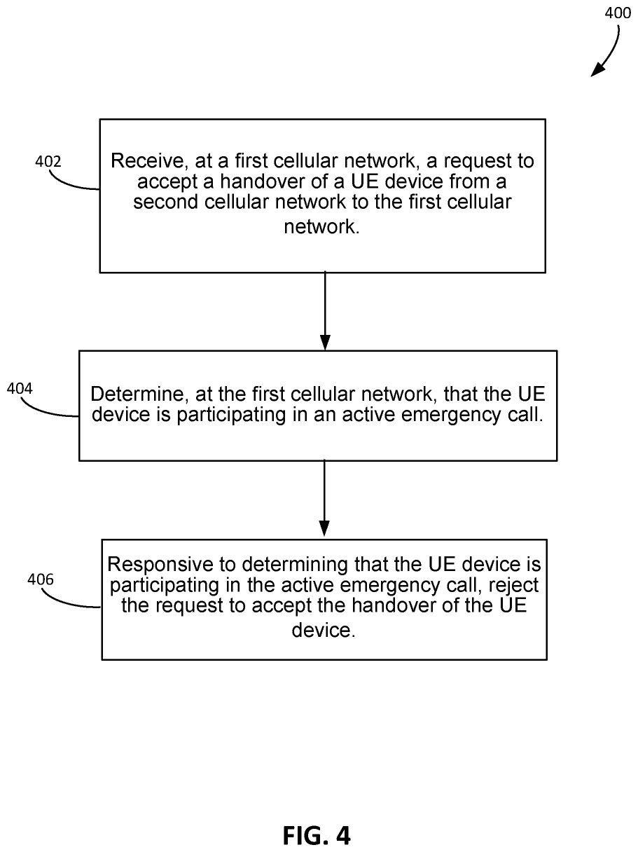

FIG. 4 illustrates an example process 400 for rejecting a request to accept a handover of a UE device participating in an emergency call. The operations of the process 400 can be performed by a cellular network (i.e., a cellular core network associated with the cellular radio access network that a UE device is attempting to connect to).

Operations of the process 400 include receiving, at a first cellular network, a request to accept a handover of a UE device from a second cellular network to the first cellular network (402). The first cellular network can be operated by a first service provider (e.g., Provider A), and the second cellular network can be operated by a second service provider (e.g., Provider B).

Operations of the process 400 also include determining, at the first cellular network, that the UE device is participating in an active emergency call (404). Determining that the UE device is participating in the active emergency call can include checking an Access Point Name (APN) or Data Network Name (DNN) associated with a PDU session or PDN connection of the UE device.

Operations of the process 400 further include rejecting the request to accept the handover of the UE device in response to determining that the UE device is participating in the active emergency call (406). Rejecting the request to accept the handover of the UE device can include providing the second cellular network with a code (e.g., a cause code) indicative of the UE device participating in the active emergency call.

Optionally, the operations of the process 400 can include accepting, at the first cellular network, a subsequent handover of the UE device (e.g., for a non-emergency call) after a termination of the active emergency call. Operations of the process 400 can also include accepting, at the first cellular network, the handover of the UE device for non-emergency PDU sessions.

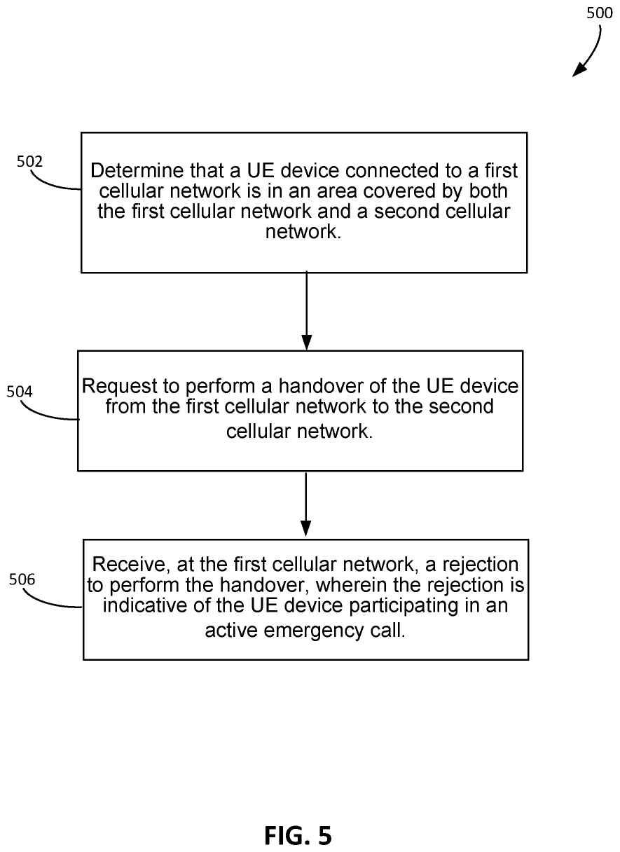

FIG. 5 illustrates an example process 500 for receiving a rejection to perform a handover of a UE device participating in an emergency call. Operations of the process 500 can be executed by a cellular network (e.g., a cellular core network associated with the cellular radio access network that a UE device is connected to).

Operations of the process 500 include determining that a user equipment (UE) device connected to a first cellular network is in an area covered by both the first cellular network and a second cellular network (502). For example, the area may correspond to a boundary area, as described above in relation to FIG. 2.

Operations of the process 500 also include requesting to perform a handover of the UE device from the first cellular network to the second cellular network (504). The first cellular network can be operated by a first service provider and the second cellular network can be operated by a second service provider. For example, the first cellular network can correspond to Provider B's cellular network and the second cellular network can correspond to Provider A's cellular network, as described above. The UE device can be subscribed to the second service provider.

Operations of the process 500 also include receiving, at the first cellular network, a rejection to perform the handover, wherein the rejection is indicative of the UE device participating in an active emergency call (506). Receiving the rejection to perform the handover can include receiving a code indicative of the UE device participating in the active emergency call, as described above in relation to FIG. 2.

Optionally, operations of the process 500 can further include continuing to carry the active emergency call subsequent to receiving the rejection to perform the handover. The operations can optionally include sending a second request to perform the handover of the UE device from the first cellular network to the second cellular network subsequent to a termination of the active emergency call (e.g., for a non-emergency PDU session).

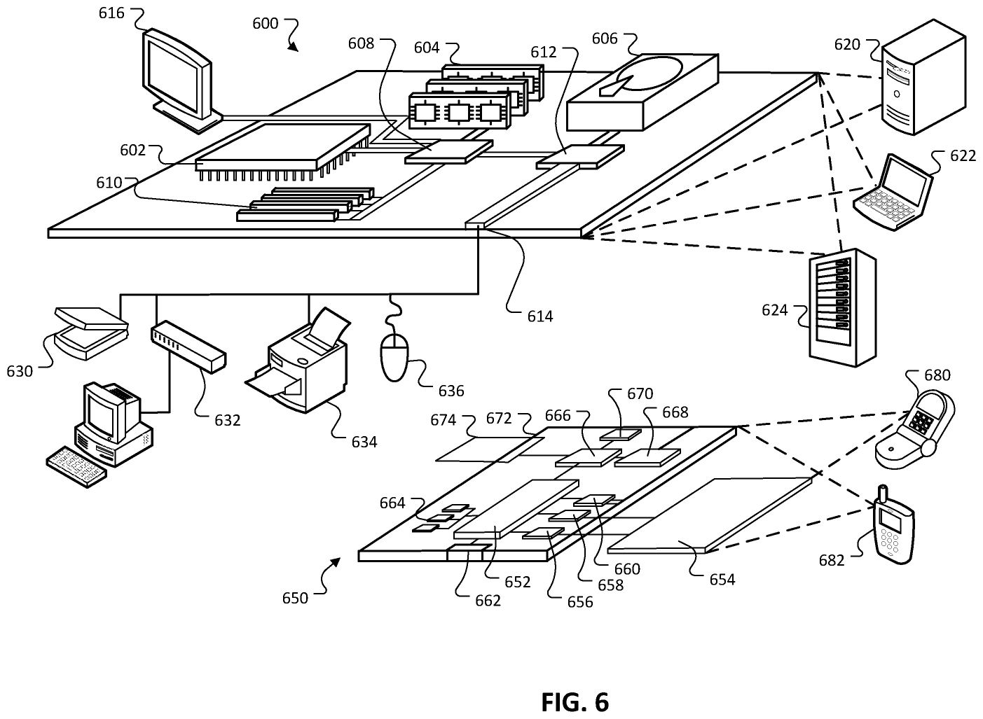

FIG. 6 shows an example of a computing device 600 and a mobile computing device 650 that are employed to execute implementations of the present disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 600 and/or the mobile computing device 650 can form at least a portion of the network environments (e.g., environment 100) described above. The computing device 600 and/or the mobile computing device 650 can also form at least a portion of the UE devices (e.g., UE device 144) described above. In some implementations, the network functions and/or network entities described above can be implemented using a cloud infrastructure including multiple computing devices 600 and/or mobile computing devices 650.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the storage device 604. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable mediums, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 614 through a network adapter. Such network input/output devices may include, for example, a switch or router.

The computing device 600 may be implemented in a number of different forms, as shown in the FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652; a memory 664; an input/output device, such as a display 654; a communication interface 666; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate. In some implementations, the mobile computing device 650 may include a camera device(s).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced

Instruction Set Computer (RISC) processor, or a Minimal Instruction Set Computer (MISC) processor. The processor 652 may provide, for example, for coordination of the other components of the mobile computing device 650, such as control of user interfaces (UIs), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module

(SIMM) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 5G technologies. Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. For example, it may be implemented in the UE described with respect to FIG. 1. Other implementations may include a phone device 680, a personal digital assistant 682, and a tablet device (not shown). The mobile computing device 650 may also be implemented as a component of a smart-phone, AR device, or other similar mobile device.

The computing device 600 may be implemented in the network environment 100 described above with respect to FIGS. 1-5.

Computing device 600 and/or 650 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments.

What is claimed is:

1. A method comprising:
determining that a user equipment (UE) device connected to a first cellular radio access network is in an area covered by both the first cellular radio access network and a second cellular radio access network,
wherein the first cellular radio access network is operated by a first service provider and the second cellular radio access network is operated by a second service provider;
identifying, at the UE device, that the second cellular radio access network is broadcasting an identifier associated with the first service provider; and
performing a handover of the UE device from the first cellular radio access network to the second cellular radio access network using the identifier associated with the first service provider.

2. The method of claim 1, wherein the UE device is subscribed to the first service provider.

3. The method of claim 1, further comprising identifying, at the second cellular radio access network, that the UE device is subscribed to the first service provider rather than the second service provider based on the identifier.

4. The method of claim 1, wherein the identifier is a multi-operator core networks (MOCN) PLMN.

5. The method of claim 1, further comprising determining, prior to performing the handover of the UE device, that the identifier is included in a list of candidate identifiers stored at the UE device.

6. The method of claim 5, wherein other identifiers included in the list of candidate identifiers are associated with the first service provider and are broadcasted by other service providers that operate other cellular radio access networks.

7. The method of claim 1, further comprising:
comparing, prior to performing the handover of the UE device, a signal strength of the first cellular radio access network with a first threshold value,
comparing, prior to performing the handover of the UE device, a signal strength of the second cellular radio access network with a second threshold value,
determining that the signal strength of the first cellular radio access network satisfies a first threshold condition for initiating the handover of the UE device, and
determining that the signal strength of the second cellular radio access network satisfies a second threshold condition for initiating the handover of the UE device.

8. The method of claim 7, wherein determining that the signal strength of the first cellular radio access network satisfies the first threshold condition comprises determining, at the UE device, that the signal strength of the first cellular radio access network satisfies the first threshold condition, and
wherein determining that the signal strength of the second cellular radio access network satisfies the second threshold condition comprises determining, at the UE device, that the signal strength of the second cellular radio access network satisfies the second threshold condition.

9. The method of claim 7, wherein determining that the signal strength of the first cellular radio access network satisfies the first threshold condition comprises determining, at the first cellular radio access network, that the signal strength of the first cellular radio access network satisfies the first threshold condition, and
wherein determining that the signal strength of the second cellular radio access network satisfies the second threshold condition comprises determining, at the first cellular radio access network, that the signal strength of the second cellular radio access network satisfies the second threshold condition.

10. The method of claim 1, further comprising configuring, at the UE device, a different identifier that is broadcast by the second cellular radio access network, wherein the different identifier enables the UE device to perform handover or cell reselection to the second cellular radio access network when the UE device enters an area that is not covered by the first cellular radio access network.

11. The method of claim 1, further comprising reestablishing a connection of the UE device with the first cellular radio access network subsequent to performing the handover of the UE device from the first cellular radio access network to the second cellular radio access network.

12. The method of claim 11, further comprising waiting for an active call or a data session to terminate at the UE device and waiting for the UE device to enter an idle mode prior to reestablishing the connection of the UE device with the first cellular radio access network.

13. A system comprising:
a first cellular radio access network operated by a first service provider;
a second cellular radio access network operated by a second service provider; and
a UE device connected to the first cellular radio access network,
wherein, when the UE device is located in an area covered by both the first cellular radio access network and the second cellular radio access network, the UE device is configured to identify that the second cellular radio access network is broadcasting an identifier associated with the first service provider, and
wherein the first cellular radio access network is configured to perform a handover of the UE device from the first cellular radio access network to the second cellular radio access network using the identifier associated with the first service provider.

14. The system of claim 13, wherein the identifier associated with the first service provider distinguishes subscribers to the first service provider that are connected to the second cellular radio access network from subscribers to the second service provider that are connected to the second cellular radio access network.

15. The system of claim 13, wherein the identifier is a multi-operator core networks (MOCN) PLMN.

16. The system of claim 13, wherein the identifier is included in a list of candidate identifiers stored at the UE device.

17. The system of claim 13, wherein the first cellular radio access network is configured to perform the handover of the UE device upon:
comparing a signal strength of the first cellular radio access network with a first threshold value;
comparing a signal strength of the second cellular radio access network with a second threshold value;
determining that the signal strength of the first cellular radio access network satisfies a first threshold condition for initiating the handover of the UE device; and
determining that the signal strength of the second cellular radio access network satisfies a second threshold condition for initiating the handover the UE device.

18. The system of claim 13, wherein the UE device is configured to reestablish a connection with the first cellular radio access network subsequent to the first cellular radio access network performing the handover of the UE device from the first cellular radio access network to the second cellular radio access network.

19. The system of claim 18, wherein the UE device does not reestablish the connection with the first cellular radio access network during an active call or a data session at the UE device.

20. A non-transitory computer readable medium storing instructions that are executable by a processing device, and upon such execution cause the processing device to perform operations comprising:
determining that a user equipment (UE) device connected to a first cellular radio access network is in an area covered by both the first cellular radio access network and a second cellular radio access network,
wherein the first cellular radio access network is operated by a first service provider and the second cellular radio access network is operated by a second service provider;
identifying, at the UE device, that the second cellular radio access network is broadcasting an identifier associated with the first service provider; and
performing a handover of the UE device from the first cellular radio access network to the second cellular radio access network using the identifier associated with the first service provider.
